(19) United States
(12) Patent Application Publication
(10) Pub. No.: US 2024/0050937 A1
(43) Pub. Date: Feb. 15, 2024

(54) PACKAGE BODY, CHANNEL DEVICE, AND MEASUREMENT APPARATUS

(71) Applicant: KYOCERA Corporation, Kyoto-shi, Kyoto (JP)

(72) Inventor: Takeshi IKEMOTO, Kyoto-shi, Kyoto (JP)

(21) Appl. No.: 18/267,081

(22) PCT Filed: Dec. 14, 2021
(86) PCT No.: PCT/JP2021/045932

§ 371 Date: Jun. 13, 2023

(30) Foreign Application Priority Data
Dec. 18, 2020 (JP) 2020-210676

(51) Int. Cl. B01L 3/00

(52) U.S. Cl. CPC B01L 3/502; B01L 2300/0672; B01L 2300/044; B01L 2300/0887

(57) ABSTRACT

A package body configured to break a lid member included in the package body with a small pressure is provided with a container including a bottom portion, a wall portion and an opening portion, and a lid member closing the opening portion. The lid member includes a first layer member and a second layer member layered on the first layer member, the second layer member includes a penetrating portion penetrating through the second layer member in a plan view of the lid member, and the penetrating portion has a shape extending in one direction and is located to overlap the center of the opening portion.

### TECHNICAL FIELD

The present disclosure relates to a package body, a channel device, and a measurement apparatus.

### BACKGROUND OF INVENTION

Patent Document 1 describes a microchannel device through which a liquid flows.

### CITATION LIST

### Patent Literature

Patent Document 1: JP 2015-166707 A

### SUMMARY

A package body according to an aspect of the present disclosure includes: a container including a bottom portion, a wall portion disposed on the bottom portion, and an opening portion surrounded by the wall portion; and a lid member disposed on the wall portion and configured to close the opening portion, wherein the lid member includes a first layer member and a second layer member layered on the first layer member, the second layer member includes a penetrating portion penetrating through the second layer member in a plan view of the lid member, and the penetrating portion has a shape extending in one direction and is located to overlap a center of the opening portion.

### BRIEF DESCRIPTION OF THE DRAWINGS

FIG. 1 is a perspective view of a channel device according to a first embodiment of the present disclosure.

FIG. 2A is a cross-sectional view taken along a line A-A illustrated in FIG. 1.

FIG. 2B is a cross-sectional view illustrating a configuration of a channel device without a package body being disposed.

FIG. 3 is a cross-sectional view illustrating a configuration of a lid member and is also an enlarged view of a region D illustrated in FIG. 2.

FIG. 4 is a plan view of a lid member.

FIG. 5 is a perspective view illustrating a measurement apparatus of an aspect of the present disclosure.

FIG. 6 is a cross-sectional view of the periphery of a package body in the measurement apparatus.

### DESCRIPTION OF EMBODIMENTS

### First Embodiment

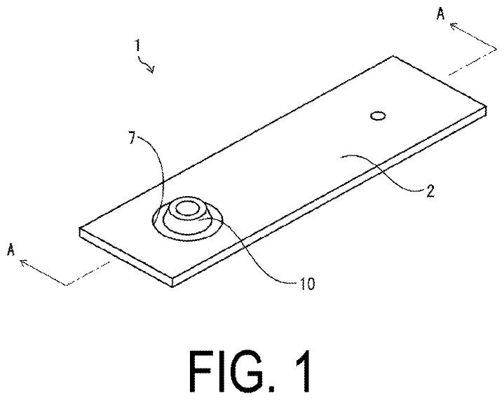

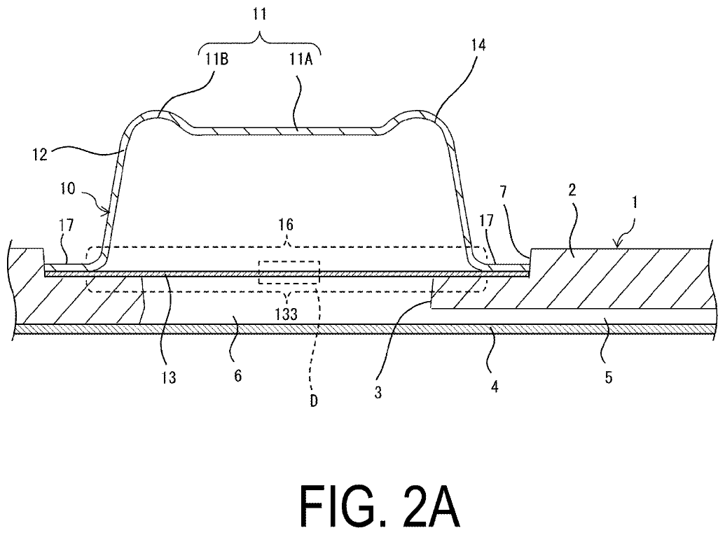

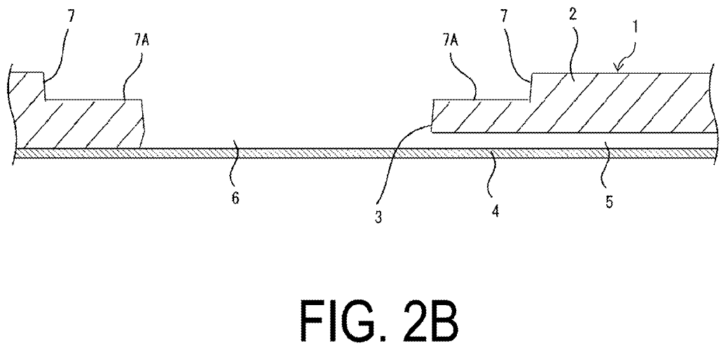

An embodiment of the present disclosure will be described in detail below. FIG. 1 is a perspective view of a channel device 1 according to a first embodiment of the present disclosure. FIG. 2A is a cross-sectional view taken along a line A-A illustrated in FIG. 1. Note that in FIG. 2, part of a channel substrate 2 described below and part of a channel 5 described below are omitted. The omitted parts are indicated by wavy lines. That is, the channel 5 may further extend downstream as compared with that illustrated in FIG. 2A, for example. The channel substrate 2 may further expand toward the upstream side or downstream side of the channel 5 as compared with that illustrated in FIG. 2A, for example. As illustrated in FIGS. 1 and 2A, the channel device 1 includes the channel substrate 2, a thin film 4, and a package body 10. In FIG. 2A, the downward direction is a direction in which gravity acts (direction of gravity). In the present disclosure, description will be made such that a position where a liquid flowing into the channel device 1 arrives first is referred to as an “upstream” position and a position where the liquid arrives later is referred to as a “downstream” position. A direction-of-gravity side is referred to as a “bottom side”, and the opposite direction side is referred to as a “top side”. Similarly to the above, a surface of the channel device 1 on the opposite side to the direction-of-gravity side is referred to as an “upper surface”.

The channel substrate 2 includes therein the channel 5, through which a liquid held in the package body 10 described below flows. The channel substrate 2 is made of resin, for example. The channel substrate 2 according to the embodiment is made of a hydrophobic material. Specifically, the channel substrate 2 may be made of, for example, a resin having a contact angle with water of 60 degrees or more. The contact angle with water of a material constituting the channel substrate 2 may be determined by, for example, a wettability testing method for a glass substrate (JIS R 3257: 1999). The above-mentioned resin is, for example, polycarbonate, cycloolefin polymer, a polymethyl methacrylate resin, or polydimethylsiloxane. The channel substrate 2 according to the embodiment is constituted by a polymethyl methacrylate resin. In the channel substrate 2 according to the embodiment, a lower surface of the channel 5 is constituted by the thin film 4.

In the channel substrate 2 of the channel device 1 according to the embodiment, the lower surface of the channel 5 is constituted by the thin film 4. Specifically, the channel device 1 may be, for example, a composite in which a thinned film as the thin film 4 is bonded to the molded channel substrate 2 with an adhesive. The adhesive is, for example, a UV curable adhesive, a multifunctional epoxy crosslinked adhesive, or a silane coupling agent. The channel substrate 2 and a member equivalent to the thin film 4 may be structurally bonded to each other.

The channel substrate 2 includes a substrate opening portion 3 that opens to the outside in an upper surface thereof. The substrate opening portion 3 is covered with a lid member 13 of the package body 10 described below. The substrate opening portion 3 may be circular. The aperture of the substrate opening portion 3 is, for example, 9 mm to 10 mm. By forming the substrate opening portion 3 in a circular shape, pressure is uniformly applied to the lid member 13 when the package body 10 is pressed, and the lid member 13 may be easily broken in a desired mode. The channel substrate 2 includes, below the substrate opening portion 3, a cavity portion 6 for receiving a liquid supplied through the substrate opening portion 3. The channel substrate 2 may include a plurality of the substrate opening portions 3.

The package body 10 holds a liquid to be injected into the channel 5. The type of liquid stored in the package body 10 is not particularly limited, and may be various reagents, cleaning liquids, or liquids containing samples used for testing. As illustrated in FIG. 2A, the package body 10 includes a container 14 and the lid member 13.

The container 14 defines a space for storing a liquid to be injected into the channel device 1. The container 14 includes a bottom portion 11 and a wall portion 12 constituting a side wall of the container 14. The bottom portion 11 is connected to one end portion of the wall portion 12 and constitutes a bottom surface of the container 14. As illustrated in FIG. 2A, when the package body 10 is installed on the channel device 1, the bottom portion 11 of the package body 10 is installed to be located above the channel device 1. An edge portion 17 is provided at the other end portion of the wall portion 12. The edge portion 17 may be formed to face a bottom surface 7A of a recessed portion 7 formed on the upper surface of the channel substrate 2. An opening portion that is visible when the container 14 is viewed in a plan view from the bottom side is referred to as an opening portion 16. The opening portion 16 is formed by an end portion on the bottom side of the wall portion 12.

The container 14 may be made of any material corresponding to the type of liquid used for the testing. For example, in a case where a liquid susceptible to oxidation is used, the container 14 may be made of a material having low oxygen permeability. For example, when an acidic liquid is used, the container 14 is required to be made of an acid-resistant material. Accordingly, the container 14 is required to be made of, for example, aluminum, polypropylene, or polyethylene. In the embodiment, the container 14 is made of polypropylene. The container 14 may be constituted by a known technique such as vacuum molding.

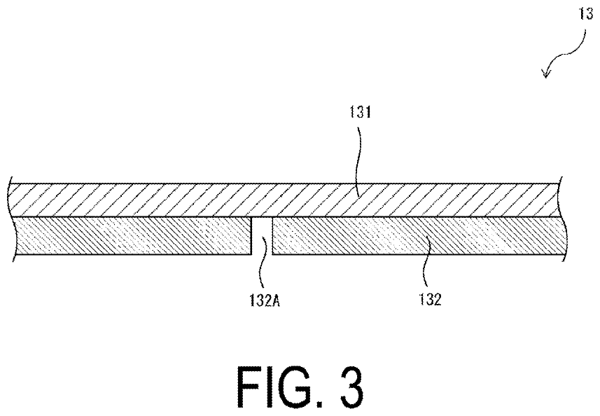

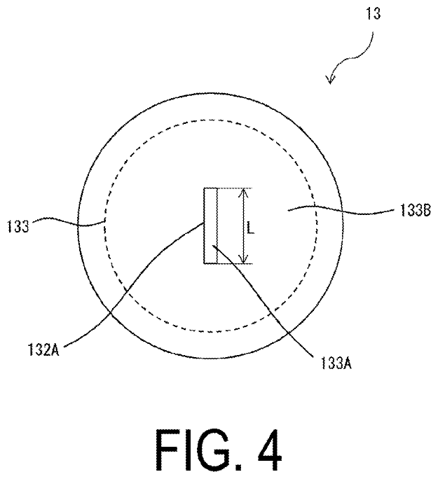

FIG. 3 is a cross-sectional view illustrating a configuration of the lid member 13 and is also an enlarged view of a region D illustrated in FIG. 2A. FIG. 4 is a plan view of the lid member 13. As illustrated in FIG. 2A, the lid member 13 is bonded to the edge portion 17 disposed at the end portion of the wall portion 12. With this configuration, the lid member 13 closes the opening portion 16 of the container 14. The lid member 13 is required to cover at least part of the edge portion 17 to such an extent that the lid member 13 is stably bonded to the edge portion 17, and need not cover the entire region of the edge portion 17. When the bottom portion 11 of the container 14 is pressed, pressure is applied to the lid member 13 to break the lid member 13. Thus, the liquid held in the container 14 may be delivered from the container 14.

As illustrated in FIG. 3, the lid member 13 has a structure in which a first layer member 131 and a second layer member 132 are layered. The first layer member 131 and the second layer member 132 may be made of different materials from each other. The first layer member 131 may be made of, for example, metal foil. The metal foil may be, for example, aluminum foil. The second layer member 132 may be made of, for example, resin. Examples of the resin include polyethylene terephthalate (PET), polyvinylidene chloride (PVDC), and a copolymer of polyvinyl chloride (PVC)) and polychlorotrifluoroethylene. The lid member 13 may include a resin layer made of resin (plastic) in addition to the first layer member 131 and the second layer member 132. The resin layer may be located on a surface of the first layer member 131 on the opposite side to the second layer member 132. The lid member 13 may be bonded to the container 14 by thermally bonding the resin layer and the wall portion 12 of the container 14.

The thickness of the first layer member 131 may be smaller than the thickness of the second layer member 132. The thickness of the first layer member 131 may be, for example, in a range from 5 μm to 10 μm. The thickness of the second layer member 132 may be in a range from 5 μm to 20 μm. The tensile fracture stress of the first layer member 131 may be smaller than the tensile fracture stress of the second layer member 132.

As illustrated in FIG. 3, the second layer member 132 includes a penetrating portion 132A penetrating through the second layer member 132 along a direction in which the first layer member 131 and the second layer member 132 are layered. Since the penetrating portion 132A is formed in the second layer member 132, when pressure is applied to the lid member 13 due to the bottom portion 11 of the container 14 being pressed, a portion where the penetrating portion 132A is formed is likely to be broken. This makes it possible to reduce the pressure applied to the package body 10 in order to break the lid member 13. An end portion of the penetrating portion 132A may be rounded. When the end portion of the penetrating portion 132A is rounded, the stress concentration at the end portion of the penetrating portion 132A may be reduced. In the cross-sectional view illustrated in FIG. 3, the side wall of the penetrating portion 132A may be inclined with respect to the first layer member such that the width increases with increasing distance from the first layer member 131. This makes it possible to efficiently apply the stress to the first layer member 131 when the package body 10 is pressed.

The penetrating portion 132A may have a shape extending in one direction when the lid member 13 is seen in a plan view. For example, the penetrating portion 132A may have a shape extending in one direction in a curved shape, or may have a shape extending in one direction having a linear region and a curved region. The curved shape may be, for example, a circular arc shape or an S-shape. In a case where the penetrating portion 132A has a shape extending in one direction, when pressure is applied to the lid member 13, stress is likely to be concentrated along the one direction. This may enhance reproducibility of the position where the lid member 13 is broken. The penetrating portion 132A may at least partially have a linear region as a shape extending in one direction. With this, when pressure is applied to the lid member 13, stress may be more likely to be concentrated along one direction. As a result, the reproducibility of the position where the lid member 13 is broken may be further enhanced.

As illustrated in FIG. 4, the penetrating portion 132A of the present embodiment may be configured by only a linear region. By forming the penetrating portion 132A only in the linear region, the likelihood of the lid member 13 being broken along the linear region is increased, and the reproducibility of the breaking position and the breaking timing of the lid member 13 may be further enhanced.

The penetrating portion 132A may be located to overlap the center of gravity of the opening portion 16 when viewed from the direction in which the first layer member 131 and the second layer member 132 are layered. As a result, when pressure is applied to the lid member 13, the stress is concentrated on the penetrating portion 132A, so that the lid member 13 is likely to be broken from the center of the lid member 13, and the pressure applied to the package body 10 in order to break the lid member 13 may be reduced. When the penetrating portion 132A has a linear region, the linear region may overlap the center of the opening portion 16. This makes it possible to increase the likelihood of the lid member 13 being broken in a desired direction and at a desired timing from the center of the lid member 13.

As illustrated in FIG. 4, the lid member 13 has a closing region 133 overlapping the opening portion 16 of the container 14 in a plan view of the lid member 13. A region surrounded by a broken line in FIG. 4 is the closing region 133. As illustrated in FIG. 2A, the lid member 13 is bonded to the edge portion 17 in a region outside the closing region 133, in other words, in a region surrounding the closing region 133.

In a plan view of the lid member 13, the closing region 133 may include a first region 133A, in which the penetrating portion 132A is disposed, and a second region 133B disposed to surround the first region 133A. The second region 133B is a region in which the first layer member 131 and a region of the second layer member 132 where the penetrating portion 132A is not disposed are layered. Since the closing region 133 has the first region 133A and the second region 133B, when the lid member 13 is broken and the liquid is delivered from the container 14, the likelihood that the liquid spreads along the edge portion 17 may be lowered, and the reproducibility of the liquid delivery direction may be enhanced.

The first layer member 131 and the second layer member 132 may be located in the order of the first layer member 131 and the second layer member 132 from the top side as illustrated in FIG. 3, or may be located in the order of the second layer member 132 and the first layer member 131 from the top side.

The bottom portion 11 may include a first bottom portion 11A and a second bottom portion 11B. The first bottom portion 11A may constitute the center of the bottom portion 11, and the second bottom portion 11B may be disposed to surround the first bottom portion 11A. The shape of the first bottom portion 11A is not particularly limited, and may take, for example, a circular shape or rectangular shape. The first bottom portion 11A of the present embodiment has a circular shape. The first bottom portion 11A of the container 14 may be arranged to face the lid member 13 as illustrated in FIG. 2A. This makes it possible to uniformly apply the stress to the lid member 13 when the package body 10 is pressed.

The second bottom portion 11B may have a shape protruding from the first bottom portion 11A to increase the volume of the container 14. Since the second bottom portion 11B protrudes from the first bottom portion 11A, when the package body 10 is installed on the channel device 1, gas mixed in the liquid stored in the package body 10 is located at the second bottom portion 11B. Thus, the likelihood of the gas entering the channel device 1 when the liquid is injected from the package body 10 into the channel device 1 can be reduced. When the second bottom portion 11B is seen in a plan view, an area of the second bottom portion 11B may be, for example, 28 mm² to 30 mm².

When the bottom portion 11 is seen in a plan view, the radius of a circle defined by the outer periphery of the second bottom portion 11B may be, for example, 11 mm. When the bottom portion 11 is seen in the plan view, the radius of a circle defined by the outer periphery of the first bottom portion 11A may be 6 mm. The second bottom portion 11B may have a curved cross-sectional shape as depicted in FIG. 2A.

The package body 10 of the embodiment may be configured as follows: when the capacity of the container 14 is denoted as Va in a case where the bottom portion of the package body 10 is constituted by only the first bottom portion 11A, that is, the second bottom portion 11B is not provided, and an increment in the capacity of the container 14 by providing the second bottom portion 11B is denoted as Vb, Expression (1) given below is satisfied.

0.15≥Vb/Va≥0.05 (1)

This configuration makes it possible to easily capture the gas mixed in the liquid in a space produced by the second bottom portion 11B. For example, when the total capacity of the container 14 is 350 μl, Vb is approximately 40 μl.

The wall portion 12 constitutes the side wall of the container 14. The wall portion 12 may have a circular shape when cut along a plane parallel to the first bottom portion 11A. The wall portion 12 may be formed such that the area thereof gradually increases as the distance from the bottom portion 11 increases. The container 14 includes the opening portion 16 surrounded by the wall portion 12 as illustrated in FIG. 2A. Since the wall portion 12 has the above-described configuration, the area of an opening of the opening portion 16 is larger than the area of the bottom portion 11. Although the opening portion 16 of the present embodiment has a circular shape, the shape is not limited to the circular shape, and may be, for example, an elliptical shape, a rectangular shape, or a trapezoidal shape.

The angle formed between the wall portion 12 and the lid member 13 in the container 14 may be 80 degrees to 90 degrees. The surface of a portion where the wall portion 12 rises from the lid member 13 may be configured by a curved surface. In this case, the rising angle of the wall portion 12 from the lid member 13 may be 10 degrees. The radius of curvature of the curved surface mentioned above may be, for example, 1.35 mm.

When the package body 10 is viewed from the direction in which the first layer member 131 and the second layer member 132 are layered, the radius of the package body 10, that is, the radius of the outer periphery of the edge portion 17 may be, for example, 16 mm, and the radius of the opening portion 16 may be, for example, 13 mm.

The package body 10 may be manufactured as follows, for example. First, a liquid is injected into the container 14. Thereafter, in a state where the first layer member 131 and the second layer member 132 are positioned at the edge portion 17 of the container 14 and then layered in such a manner as to close the opening portion 16, thermocompression bonding is performed to bond the lid member 13 to the edge portion 17. Subsequently, the penetrating portion 132A is formed in the second layer member 132 by irradiating the second layer member 132 with a CO₂ laser. The irradiation with the CO₂ laser may be performed before the thermocompression bonding.

As illustrated in FIG. 2A, the package body 10 is installed on the channel substrate 2 of the channel device 1 so that the lid member 13 is on the bottom side. More specifically, as illustrated in FIG. 2B, the package body 10 may be installed such that the edge portion 17 is located on the bottom surface 7A of the recessed portion 7 formed on the upper surface of the channel substrate 2. In this case, the lid member 13 comes into contact with the bottom surface 7A. When viewed from the direction in which the first layer member 131 and the second layer member 132 are layered, the recessed portion 7 may have a shape substantially matching the shape of the lid member 13.

The substrate opening portion 3 may be located in the bottom surface 7A of the recessed portion 7. The size of the opening portion 16 of the container 14 may be larger than that of the substrate opening portion 3, as illustrated in FIG. 2A. In other words, the substrate opening portion 3 may be covered with the opening portion 16 of the container 14 when viewed from the direction in which the first layer member 131 and the second layer member 132 are layered. When viewed from the direction in which the first layer member 131 and the second layer member 132 are layered, the center of gravity of the substrate opening portion 3 and the center of gravity of the opening portion 16 of the container 14 may overlap with each other. In this case, in a plan view of the channel device 1, the center of gravity of the penetrating portion 132A overlaps with the center of gravity of the substrate opening portion 3.

The cavity portion 6 defines a space located between the substrate opening portion 3 and the channel 5, and is constituted by part of the channel substrate 2 and the thin film 4. The cavity portion 6 may temporarily store a certain amount of liquid supplied through the substrate opening portion 3. After the liquid is once accumulated in the cavity portion 6, the liquid flows into the channel 5 located on the downstream side of the cavity portion 6. With this configuration, the momentum of the liquid flowing into the channel 5 may be controlled.

The cavity portion 6 is not limited to a specific shape as long as it can temporarily accumulate the liquid released from the package body 10. The cavity portion 6 may have any shape including, for example, a frustum such as a truncated cone, a truncated triangular cone or a truncated square cone, a pyramid such as a cone, a triangular pyramid or a quadrangular pyramid, a column such as a cylinder, a triangular prism or a quadrangular prism, or a combination thereof.

The channel device 1 according to an aspect of the present disclosure may be configured as follows: when the length of a portion of the penetrating portion 132A having a shape extending in one direction (that is, the length in a longitudinal direction of the penetrating portion 132A) is denoted as L, and the diameter of the substrate opening portion 3 is denoted as R, Expression (2) given below is satisfied. When the penetrating portion 132A includes a curved region, the length L is defined as a distance between both end portions in the longitudinal direction of the penetrating portion 132A.

0.30≥L/R≥0.24 (2)

By causing L/R to be 0.3 or less, the position at which the lid member 13 breaks may be easily controlled, and the likelihood of the lid member 13 breaking starting from the center point in the longitudinal direction of the penetrating portion 132A may be increased. By causing L/R to be 0.24 or more, the momentum of the liquid when the lid member 13 breaks may be reduced, and the likelihood of gas being mixed into the liquid may be lowered.

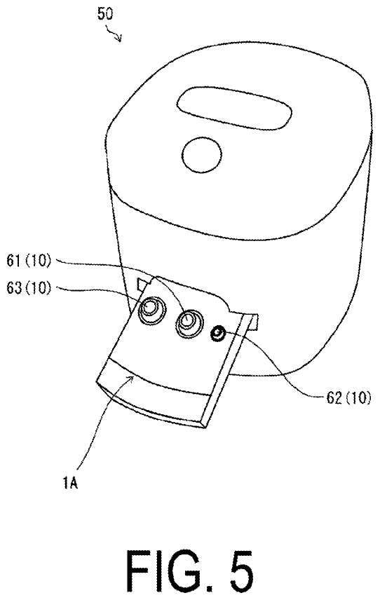

FIG. 5 is a perspective view illustrating a measurement apparatus 50 of an aspect of the present disclosure. The measurement apparatus 50 performs measurement on a liquid specimen by using a channel device 1A. The channel device 1A according to the present embodiment may include a first holding portion 61, a second holding portion 62 and a third holding portion 63, which are constituted by the package bodies 10, and a detector (not illustrated). The channel device 1A is different from the channel device 1 in that it includes a plurality of package bodies 10, but is the same or similar to the channel device 1 in terms of the structural relationship between the channel substrate 2 and the package body 10. The first holding portion 61 may hold a buffer solution, the second holding portion 62 may hold a sample liquid, and the third holding portion 63 may hold a buffer solution. The detector may measure, for example, an antigen contained in the sample liquid held in the second holding portion 62. The number of package bodies 10 included in the channel device 1 and the type of liquid enclosed in each package body 10 are not limited to those described above.

The channel device 1 is not limited to a configuration in which all of the first holding portion 61, the second holding portion 62, and the third holding portion 63 are constituted by the package bodies 10, and at least one selected from the group consisting of the first holding portion 61, the second holding portion 62, and the third holding portion 63 is required to be constituted by the package body 10. In this case, the channel device 1 may have a structure in which, for example, a liquid such as a reagent or a sample liquid is injected by a dropper or the like instead of the holding portion that is not constituted by the package body 10.

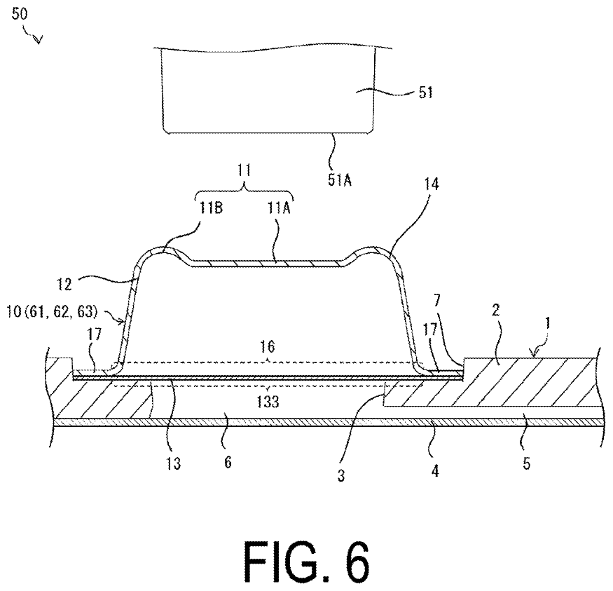

FIG. 6 is a cross-sectional view of the periphery of the package body 10 in the measurement apparatus 50. As illustrated in FIG. 6, the measurement apparatus 50 includes a pressing member 51. The pressing member 51 can press the bottom portion of the package body 10. The pressing member 51 includes a facing surface 51A facing the first bottom portion 11A of the package body 10 in a state where the channel device 1 is mounted in the measurement apparatus 50. The pressing member 51 is movable along a direction in which the first bottom portion 11A and the facing surface 51A face each other, in other words, a direction in which the first layer member 131 and the second layer member 132 are layered. The pressing member 51 may press only the first bottom portion 11A or the first bottom portion 11A and second bottom portion 11B of the package body 10 with the facing surface 51A. The facing surface 51A may be a flat surface. The flat surface is intended not to be a curved surface at a visible level or intended to have no unevenness at a visible level, and is not required to be strictly flat. The shape of the facing surface 51A is not particularly limited, and may take, for example, a rectangular shape, a trapezoidal shape, an elliptical shape, or a circular shape. In the present embodiment, the facing surface 51A has a circular shape. The facing surface 51A may have a circular shape with a diameter of 8.5 mm, for example.

When the pressing member 51 and the package body 10 are viewed from a direction in which the facing surface 51A and the first bottom portion 11A face each other, the facing surface 51A may be located to face the entire surface of the first bottom portion 11A and part of the second bottom portion 11B. That is, the area of the facing surface 51A may be greater than the area of the first bottom portion 11A. In this case, when the pressing member 51 presses the package body 10, the entire surface of the first bottom portion 11A and part of the second bottom portion 11B are crushed by the pressing member. In this case, the gas that is mixed in the liquid stored in the package body 10 is captured in the other part of the second bottom portion 11B that is not pressed by the pressing member 51, and thus the likelihood of the gas entering the channel device 1 may be lowered. Since the area of the bottom portion 11 pressed by the pressing member 51 is larger than the area of the first bottom portion 11A, the amount of liquid delivered per unit movement distance of the pressing member 51 may be increased.

The facing surface 51A may face at least part of the first bottom portion 11A to be surrounded by the second bottom portion 11B in a plan view of the facing surface 51A. That is, the facing surface 51A may be located on the inner side relative to the inner periphery of the second bottom portion 11B in the plan view of the facing surface 51A. In this case, the area of the facing surface 51A is made to be equal to or smaller than the area of the first bottom portion 11A.

In the present disclosure, the invention has been described above based on the various drawings and examples. However, the invention according to the present disclosure is not limited to each embodiment described above. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, a person skilled in the art can easily make various variations or modifications based on the present disclosure. Note that these variations or modifications are included within the scope of the present disclosure.

### REFERENCE SIGNS

1 Channel device
2 Channel substrate
3 Substrate opening portion
5 Channel
6 Cavity portion
10 Package body
11 Bottom portion
11A First bottom portion
11B Second bottom portion
12 Wall portion
13 Lid member
14 Container
16 Opening portion
17 Edge portion
50 Measurement apparatus
51 Pressing member
51A Facing surface
131 First layer member
132 Second layer member
132A Penetrating portion
133 Closing region
133A First region
133B Second region

1. A package body, comprising:
a container comprising a bottom portion, a wall portion disposed on the bottom portion, and an opening portion surrounded by the wall portion; and
a lid member disposed on the wall portion and configured to close the opening portion, the lid member comprising:
a first layer member, and
a second layer member layered on the first layer member, the second layer member comprising:
a penetrating portion penetrating through the second layer member in a plan view of the lid member, and having a shape extending in one direction that overlaps a center of the opening portion.

2. The package body according to claim 1, wherein
the shape extending in the one direction of the penetrating portion comprises a linear region, and
the linear region overlaps the center.

3. The package body according to claim 2, wherein
the penetrating portion is constituted by only the linear region.

4. The package body according to claim 1, wherein
the lid member comprises a closing region overlapping the opening portion in the plan view of the lid member, and
the closing region comprises a first region in which the penetrating portion is disposed and a second region that surrounds the first region in the plan view.

5. The package body according to claim 1, wherein
the bottom portion comprises a first bottom portion and a second bottom portion protruding from the first bottom portion whereby a volume of the container increases.

6. The package body according to claim 5, wherein
the second bottom portion is disposed to surround the first bottom portion.

7. The package body according to claim 6, wherein
the first bottom portion faces the lid member.

8. The package body according to claim 1, wherein
an area of the opening portion is larger than an area of the bottom portion.

9. The package body according to claim 5, wherein
when a capacity of the container is denoted as Va, and an increment in capacity of the container by providing the second bottom portion is denoted as Vb, Expression (1) given below is satisfied.
0.15≥Vb/Va≥0.05 (1)

10. A channel device, comprising:
the package body according to claim 1; and
a channel substrate, the channel substrate comprising:
a substrate opening portion opened to an outside,
a channel located in an inner portion of the channel substrate, and
a cavity portion connected to the channel and configured to receive a liquid supplied through the substrate opening portion, wherein
the substrate opening portion is covered with the lid member.

11. The channel device according to claim 10, wherein
the substrate opening portion is circular.

12. The channel device according to claim 11, wherein
when a length of the shape extending in the one direction is denoted as L, and a diameter of the substrate opening portion is denoted as R, Expression (2) given below is satisfied.
0.30≥L/R≥0.24 (2)

13. The channel device according to claim 10, wherein
a center of gravity of the penetrating portion overlaps with a center of gravity of the substrate opening portion in a plan view of the channel device.

14. The channel device according to claim 10, wherein
the channel substrate is made of a hydrophobic material.

15. A measurement apparatus, comprising:
the package body according to claim 5; and
a pressing member comprising a facing surface facing the first bottom portion and configured to press the bottom portion with the facing surface.

16. The measurement apparatus according to claim 15, wherein
when the pressing member and the package body are viewed from a direction in which the facing surface and the first bottom portion face each other, the facing surface is located to face an entire surface of the first bottom portion and part of the second bottom portion.

17. The measurement apparatus according to claim 15, wherein
the facing surface is a flat surface.
